(19) United States
(12) Patent Application Publication
(10) Pub. No.: US 2010/0048209 A1
(43) Pub. Date: Feb. 25, 2010

(54) Wireless Communication Terminal Apparatus and Wireless Communication Method

(75) Inventors: Takahisa Aoyama, Kanagawa (JP); Hong Tat Toh, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/593,576

(22) PCT Filed: Mar. 28, 2008
(86) PCT No.: PCT/JP2008/000804

§ 371 Date: Sep. 28, 2009

(30) Foreign Application Priority Data
Mar. 30, 2007 (JP) 2007-092776
May 1, 2007 (JP) 2007-120849

(51) Int. Cl. H04W 36/00

(52) U.S. Cl. 455/435.2

(57) ABSTRACT

A wireless communication terminal apparatus and a wireless communication method wherein a measurement operation, which is suitable for a long DRX/DTX interval, is controlled without providing any new signaling between a terminal and a base station. When a DRX threshold terminal status determining part (107) determines that a set a DRX/DTX interval is longer than a DRX threshold, a measurement process deciding part (108) instructs a measurement implementing part (109) to use information for cell reselection. The measurement implementing part (109) then uses the information for cell reselection to perform a measurement. When a result of the measurement satisfies a cell reselection requirement, a measurement report transmission process deciding part (110) decides a transmission of a measurement report, which is then transmitted from a transmitting part (111) to a wireless communication base station apparatus currently connected.

### TECHNICAL FIELD

The present invention relates to a radio communication terminal apparatus and a radio communication method for carrying out DRX (discontinuous reception)/DTX (discontinuous transmission).

### BACKGROUND ART

According to the 3GPP UMTS system release 1999 and its equivalent that have been standardized, there are roughly two states that are subject to state management in the RRC (Radio Resource Control) of terminals (see Non-Patent Document 1). These are the two states: the RRC connected state and the RRC idle state. The RRC-connected state is further divided into four states, that is, the CELL_DCH state, the CELL_FACH state, the CELL_PCH state and the URA_PCH state. These four states will be briefly explained below.

The CELL_DCH state refers to a state in which a terminal and a base station are connected via a dedicated channel and in which substantial power is consumed because transmission and reception go on on a constant basis. Furthermore, since a dedicated channel is set up, transmission and reception of large data are possible. Furthermore, the mobility control is a network control, in which, in response to measurement reports from terminals, cell-change commands are issued from the network.

The CELL_FACH state refers to a state in which transmission and reception between a terminal and base station are carried out using a shared channel, and in which less power is consumed than in CELL_DCH because transmission and reception are carried out only when necessary. Furthermore, since a plurality of terminals carry out transmission and reception using limited shared channels, CELL_FACH is not suitable for transmission and reception of large data. Furthermore, the mobility control is a terminal control, in which, when a terminal moves between cells, the terminal needs to change its state to CELL_DCH or CELL_FACH and register the new cell (i.e. cell update).

The CELL_PCH state refers to a state in which a terminal waits for generation of new data or a call from a base station and in which no data is transmitted or received. Moreover, setup information for earlier services and so on are left. Furthermore, move within a cell involves only waiting at discontinuous reception (DRX) intervals, so that little power is consumed. Furthermore, the mobility control is a terminal control, in which, when a terminal moves between cells, the terminal needs to change its state to CELL_DCH or CELL_FACH and register the new cell.

The URA_PCH state refers to a state in which a terminal waits for generation of new data or a call from a base station and in which no data is transmitted or received. Moreover, setup information for earlier services and so on are left. Furthermore, move within the URA (UTRAN Registration Area) (a plurality of cell groups) involves only waiting, so that little power is consumed. Furthermore, the mobility control is a terminal control, in which, when a terminal moves between URA's, the terminal needs to change its state to CELL_DCH or CELL_FACH and register the new URA (i.e. URA update).

Next, the RRC idle state will be explained. The RRC idle state refers to a state in which a terminal waits for generation of new data or a call from a base station and in which no data is transmitted or received. Setup information for earlier services and so on are not left. Furthermore, move within the RA (Routing Area) or LA (Location Area) (a plurality of cell groups) involves only waiting, so that little power is consumed. Furthermore, the mobility control is a terminal control, in which, when a terminal moves between RA's, to the terminal needs to change its state to CELL_DCH or CELL_FACH and register the new RA (i.e. RA update).

FIG. 1 shows a conceptual diagram of RRC states and their transitions. The network side allows a terminal to transition to suitable RRC states that match the situation of the terminal using the state transition shown in FIG. 1, and, by this means, makes possible reduced power consumption of the terminal and effective the use of radio resources.

By the way, mobility involves roughly two major operations, that is, handover (CELL_DCH) carried out under network control, and cell reselection (other than CELL_DCH) whereby the terminal selects a cell by itself. In handover, a terminal reports the received quality in the subject cell and other cells to the network, and the network determines the handover destination of the terminal. The method of reporting, the method of measuring received quality and so on are reported from the network using broadcast information or using an individual RRC message (measurement control message). Furthermore, handover is carried out only in CELL_DCH, and measurement is basically carried out on a constant basis in the subject cell and in other cells.

On the other hand, in cell reselection, a terminal measures the received quality in the subject cell and other cells, and, when a specific condition is met, the terminal decides to transition to another cell. The method of measuring received quality and the criteria for selecting other cells and so on are reported in broadcast information. Furthermore, cell reselection is used except in CELL_DCH, and various parameters are provided for reduced battery consumption.

However, UMTS has two problems. The first problem is that, since there are many states, terminals and the network both require complex control, and the second problem is that, since state transition is carried out using RRC messages and is time-consuming, it is difficult to make transitions frequently.

Therefore, studies are currently underway for efficient terminal state management under LTE (Long Term Evolution)/SAE (System Architecture Evolution), whose standardization is in progress by the 3GPP, aiming to adopt only two states: the RRC connected state and the RRC idle state (see Non-Patent Document 2).

In the RRC connected state, data transmission and reception between a terminal and base station are carried out using a shared channel that is shared among a plurality of terminals, and also using a control channel for using the shared channel. Furthermore, when no data exists, power consumption is reduced by carrying out discontinuous reception (DRX)/discontinuous transmission (DTX). Furthermore, the amount of data transmitted or received is controlled through allocation of shared channel resources. Furthermore, the mobility control is a network control, in which, in response to measurement reports from terminals, cell-change commands are issued from the network.

On the other hand, the RRC idle state refers to a state in which a terminal waits for generation of new data and a call from the base station, and in which no data is transmitted or received. Setup information for earlier services and so on are not left. Furthermore, move within the TA (Tracking Area) (a plurality of cell groups) involves only waiting, so that little power is consumed. Furthermore, the mobility control is a terminal control, in which a terminal can move between cells within the TA without reporting anything to the network. When a terminal moves between TA's, the terminal needs to change its state to the RRC connected state and register the new TA (i.e. TA update).

Thus, contrary to conventional UMTS, according to LTE/SAE, terminals that communicate on a constant basis and terminals that are subject to DRX/DTC control, are managed in one state.

Non-Patent Document 1: 3GPP, TS25.331, 3rd Generation Partnership Project, Technical Specification Group Radio Access Network, Radio Resource Control (RRC), Protocol Specification. Non-Patent Document 2: 3GPP, TS25.813, 3rd Generation Partnership Project, Technical Specification Group Radio Access Network, Evolved Universal Terrestrial Access (E-UTRA) and Evolved Universal Terrestrial Radio Access Network (E-UTRAN), Radio interface protocol aspects.

### DISCLOSURE OF INVENTION

### Problems to be Solved by the Invention

However, measurement for conventional network-based mobility (handover) provides no parameters that cause reduction of power consumption. Furthermore, terminals that do not use DRX/DTX need not even consider reducing power consumption, and therefore there are two possible types of operations, as shown in FIG. 2.

As shown in FIG. 2A, the first operation relates to a method of reporting to a terminal both the measurement setup to be used when DRX/DTX is not performed or when the DRX/DTX interval is short, and the measurement setup to be used when the DRX/DTX interval is long, and then determining the measurement setup to be used on the terminal side according to the specified DRX length. Although with this method the number of times measurement is set up can be reduced, many parameters need to be included in one message, and, consequently, messages become complex.

The second operation relates to a method as shown in FIG. 2B, whereby, every time the length of DRX is specified, the measurement setup to be used by the terminal is reported from the network according to the specified DRX length. Although with this method the parameters to be used when DRX is long can be optimized within a cell, “measurement control” needs to be transmitted every time a change in DRX is made,

It is therefore an object of the present invention to provide a radio communication terminal apparatus and radio communication method for controlling measurement operation suitable for long DRX/DTX intervals without providing additional signaling between a terminal and a base station.

### Means for Solving the Problem

The radio communication terminal apparatus of the present invention adopts a configuration including: a determining section that determines whether or not a discontinuous reception/discontinuous transmission interval in a radio resource control connected state is longer than a predetermined value; a measurement section that performs measurement using information for cell reselection when the discontinuous reception/discontinuous transmission interval is longer than the predetermined value; and a transmission section that transmits a measurement report to a currently connecting radio communication base station apparatus, on condition that the measurement result meets the cell reselection standard.

### ADVANTAGEOUS EFFECTS OF INVENTION

According to the present invention, it is possible to control measurement operation suitable for long DRX/DTX intervals without providing additional signaling between terminals and base station.

### BRIEF DESCRIPTION OF DRAWINGS

FIG. 1 is a conceptual diagram showing an RRC state and state transition thereof;

FIG. 2 shows a change of measurement operation accompanying a change of DRX setup;

FIG. 3 is a block diagram showing a configuration of a terminal according to Embodiment 1 of the present invention;

FIG. 4 is a block diagram showing a configuration of a base station according to Embodiment 1 of the present invention;

FIG. 5A shows information for cell reselection;

FIG. 5B shows information for handover;

FIG. 6 is a sequence diagram showing the steps for communication between the terminal shown in FIG. 3 and the base station shown in FIG. 4;

FIG. 7A shows information for cell reselection;

FIG. 7B shows information for handover;

FIG. 8A shows information for cell reselection;

FIG. 8B shows individual handover control information;

FIG. 9 is a block diagram showing a configuration of a terminal according to Embodiment 2 of the present invention;

FIG. 10 shows management in groups of information for cell reselection and information for handover;

FIG. 11 is a block diagram showing a configuration of a terminal according to Embodiment 3 of the present invention;

FIG. 12 is a block diagram showing a configuration of a terminal according to Embodiment 4 of the present invention;

FIG. 13 shows information for handover;

FIG. 14 is a block diagram showing a configuration of a terminal according to Embodiment 5 of the present invention;

FIG. 15 is a flowchart showing detailed operations of the measurement processing determining section shown in FIG. 14;

FIG. 16 is a flowchart showing operations of the terminal when longer DRX than DRX_th is set;

FIG. 17 is a flowchart showing operations of the terminal when there are a plurality of measurement setups for handover; and

FIG. 18 is a flowchart showing another operation of the terminal when there are a plurality o f measurement setups for handover.

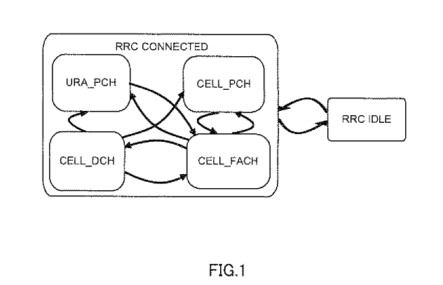

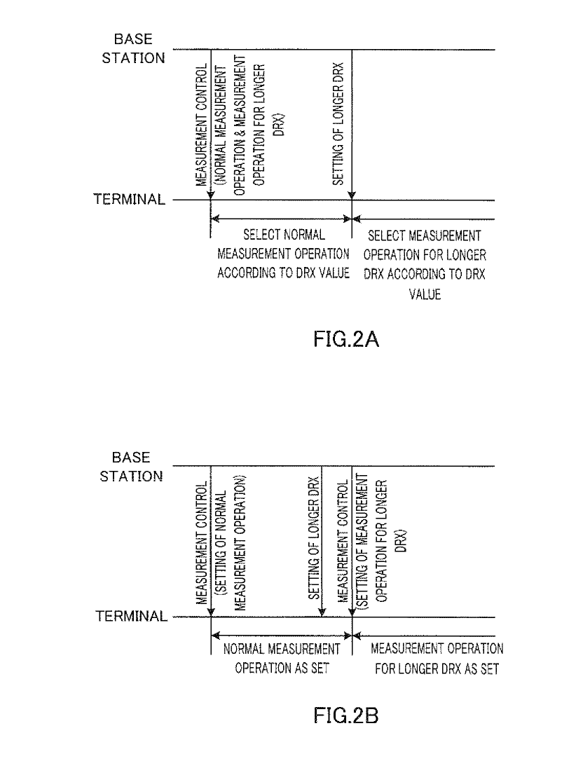

### BEST MODE FOR CARRYING OUT THE INVENTION

Hereinafter, embodiments of the present invention will be explained in detail below with reference to the accompanying drawings. However, components having the same function in the embodiments will be assigned the same reference numerals and overlapping explanations will be omitted.

### Embodiment 1

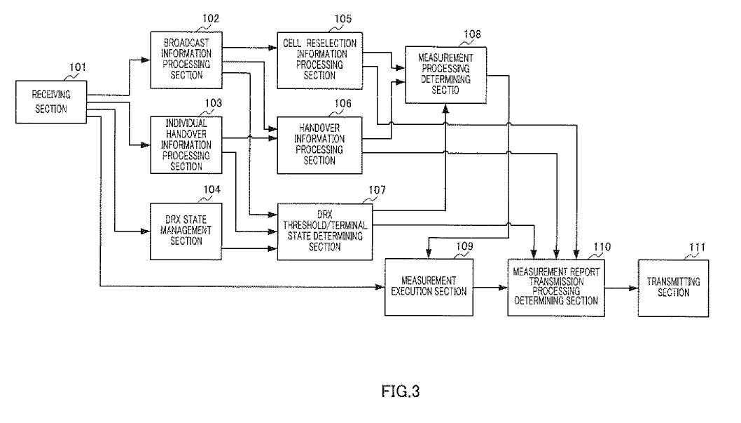

FIG. 3 is a block diagram showing a configuration of a terminal according to Embodiment 1 of the present invention. In this figure, receiving section 101 receives a signal transmitted from a base station, outputs, when a received message is broadcast information, the received message to broadcast information processing section 102, outputs, when the received message is individual handover information, the received message to individual handover information proc e s sing section 103, and outputs, when the received message is DRX control information, the received message to DRX state management section 104. Furthermore, receiving section 101 outputs the received signal to measurement execution section 109.

Broadcast information processing section 102 outputs, when the broadcast information outputted from receiving section 101 is information for cell reselection, control information thereof to cell reselection information processing section 105, and outputs, when the broadcast information is handover control information thereof to handover information processing section 106 and DRX threshold/terminal state determining section 107.

Here, examples of information for cell reselection include the following information transmitted using SIB3 or SIB4 in UMTS. (1) The measurement method for cell reselection (example: Ec/NO or RSCP); (2) the received quality in the source cell, which serves as a reference in intra-frequency measurement, (3) the received quality in the source cell, which serves as a reference in inter-frequency measurement, (4) the received quality in the source cell, which serves as a reference in contemplating HCS (hierarchical cell structure), (5) candidates of different systems and the received quality in the source cell, which serves as a reference in inter-system measurement with the candidates, (6) the offset of each cell used to determine cell reselection, (7) the hysteresis of the time cell reselection is determined, (8) the frequency cell reselection is determined, (9) the parameters used to determine the mobility of the terminal, (10) HCS-related priority information, and so on. However, these are simply examples of information to perform cell reselection, and only some of them may be used or other information may be used.

Furthermore, information for handover refers to control information for execution and reporting of measurement, and examples include the following information transmitted using measurement control messages in UMTS. (1) Measurement ID, (2) measurement method for measurement, (3) the form at of values to be embedded in reporting, (4) the reference in carrying out reporting (conditions for a specific trigger when such a trigger is used (when other cells become optimal and so on) or regular transmission and so on), (5) offset information for each cell used to determine reporting, (6) the frequency band to be measured (in the case of inter-frequency/inter-system measurement), (7) information related to the setup of gaps (in the case of inter-frequency/inter-system measurement).

Furthermore, the DRX-related information outputted from broadcast information processing section 102 to DRX threshold/terminal state determining section 107 is a reference value (DRX_th) indicating whether the DRX/DTX value used by the terminal is to be subjected to processing for handover or cell reselection.

When the received message outputted from receiving section 101 is information for handover, individual handover information processing section 103 outputs control information thereof to handover information processing section 106 and DRX threshold/terminal state determining section 107. Furthermore, individual handover information processing section 103 outputs state information (the RRC idle or RRC connected state) of the terminal to DRX threshold/terminal state determining section 107.

DRX state management section 104 controls DRX/DTX based on DRX control information outputted from receiving section 101 and outputs the state of DRX/DTX control to DRX threshold/terminal state determining section 107.

Cell reselection information processing section 105 manages information for cell reselection and so on outputted from broadcast information processing section 102 and outputs the information for cell reselection to be used currently to measurement processing determining section 108 and measurement report transmission processing determining section 110.

Here, information outputted from cell reselection information processing section 105 to measurement processing determining section 108 is portion related to execution of measurement, including the following examples. (1) Measurement method for cell reselection (example: Ec/NO or RSCP), (2) the received quality in the source cell, which serves as a reference in intra-frequency measurement, (3) the received quality in the source cell, which serves as a reference in inter-frequency measurement, (4) the received quality in the source cell, which serves as a reference in contemplating HCS (Hierarchical Cell Structure), (5) candidates of different systems and the received quality in the source cell, which serves as a reference in carrying out inter-system measurement for the candidates, (6) parameter to be used to determine the mobility of the terminal, (7) HCS-related priority information, and so on.

Furthermore, information outputted from cell reselection information processing section 105 to measurement report transmission processing determining section 110 is information about the reference in reselection, including the following examples. (1) Offset of each cell to be used to determine cell reselection, (2) hysteresis of the time cell reselection is determined, (3) frequency of executing cell reselection.

Handover information processing section 106 manages the information for handover outputted from broadcast information processing section 102 and the information for handover outputted from individual handover information processing section 103, and outputs information for handover to be currently used to measurement processing determining section 108 and measurement report transmission processing determining section 110.

Here, information outputted from handover information processing section 106 to measurement processing determining section 108 is portion related to execution of measurement, including the following examples. (1) Measurement ID, (2) measurement method for measurement, (3) the frequency band to be measured (in the case of inter-frequency/inter-system measurement), (4) information about the setup of gaps (in the case of inter-frequency/inter-system measurement).

Furthermore, information outputted from handover information processing section 106 to measurement report trans mission processing determining section 110 is information about the reference in reporting, including the following examples. (1) Measurement ID, (2) the format of values to be embedded in reporting, (3) reference in reporting (conditions for a specific trigger when such a trigger is used (when other cells become optimal and so on) or regular transmission and so on), (4) offset information for each cell used to determine reporting.

When the state of the terminal reported from individual handover information processing section 103 is the RRC idle state, DRX threshold/terminal state determining section 107 determines to use information for cell reselection. On the other hand, in the RRC connected state, DRX threshold/terminal state determining section 107 compares the length of currently used DRX/DTX outputted from DRX state management section 104 with DRX_th and commands measurement processing determining section 108 and measurement report transmission processing determining section 110 to set one of cell reselection and handover based on the comparison result.

Measurement processing determining section 108 selects one of the information for cell reselection outputted from cell reselection information processing section 105 and the information for handover outputted from handover information processing section 106 according to the setup outputted from DRX threshold/terminal state determining section 107 and commands measurement execution section 109 to set up measurement using the selected information.

Measurement execution section 109 executes measurement using the received signal outputted from receiving section 101 (reference signal such as common pilot channel (CPICH) in UMTS and so on or a reference signal of a different channel when such a channel is used as a reference signal in LTE and so on). The measurement result is transmitted to measurement report transmission processing determining section 110.

Measurement report transmission processing determining section 110 selects one of the information for cell reselection outputted from cell reselection information processing section 105 and the information for handover outputted from handover information processing section 106, according to the setup outputted from DRX threshold/terminal state determining section 107, and determines whether or not to create a measurement report based on the selected information. When a measurement report is created, such a measurement report is created using the measurement result outputted from measurement execution section 109. The measurement report created is outputted to transmitting section 111. When DRX threshold/terminal state determining section 107 reports that the state of the terminal is the RRC idle state, processing on the measurement report is not performed.

Transmitting section 111 transmits the measurement report outputted from measurement report transmission processing determining section 110.

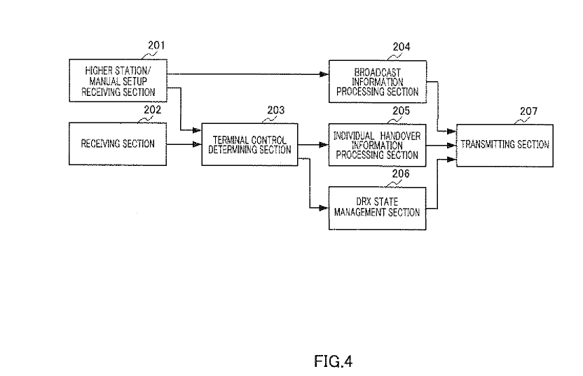

FIG. 4 is a block diagram showing a configuration of a base station according to Embodiment 1 of the present invention. In this figure, higher station/manual setup receiving section 201 receives a signal from a higher station or receives a manual setup and so on, and thereby determines how to perform the setup. The determined setup is outputted to terminal control determining section 203 and broadcast information processing section 204.

Receiving section 202 receives information transmitted from the terminal shown in FIG. 3 and outputs the received information to terminal control determining section 203.

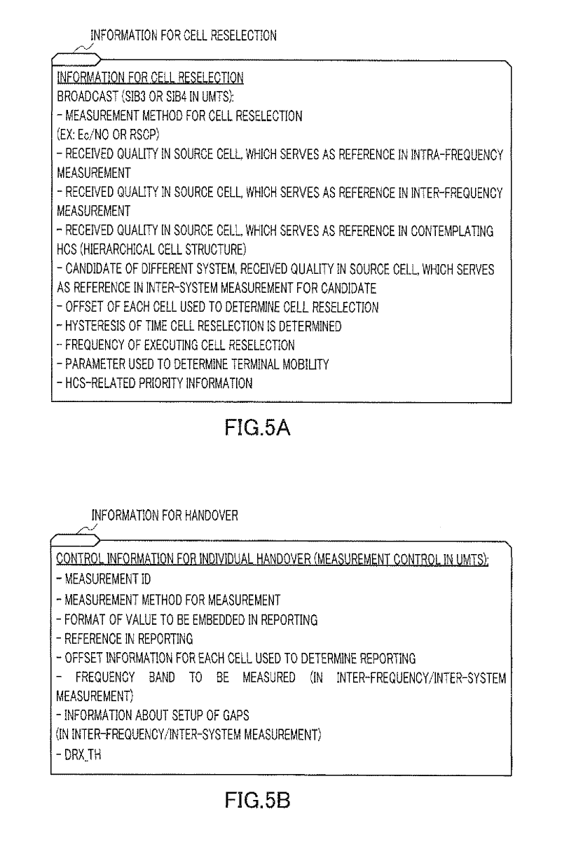

Terminal control determining section 203 determines control on the terminal based on the setup determined by higher station/manual setup receiving section 201 and the information outputted from receiving section 202. Content of the determined control are outputted to individual handover information processing section 205 and DRX state management section 206. To be more specific, terminal control determining section 203 determines the content of measurement control to be created in individual handover information processing section 205. The content of measurement control includes not only the content of conventional measurement control but also DRX_th as shown in FIG. 5B. Furthermore, terminal control determining section 203 determines the DRX setup/DTX as the content of the message to be created in DRX state management section 206.

Broadcast information processing section 204 determines content of broadcast information according to the information outputted from higher station/manual setup receiving section 201. To be more specific, broadcast information processing section 204 determines the setup for cell reselection shown in FIG. 5A. Furthermore, when information for handover is also included in the broadcast information, broadcast information processing section 204 also determines the content shown in FIG. 5B. The determined content are outputted to transmitting section 207.

Individual handover information processing section 205 creates a message such as measurement control by including the content determined in terminal control determining section 203 and outputs the created message to transmitting section 207.

DRX state management section 206 creates a message by including DRX/DTX control information (the length of DRX and so on) determined in terminal control determining section 203, and outputs the created message to transmitting section 207.

Transmitting section 207 transmits the broadcast information outputted from broadcast information processing section 204, the message outputted from individual handover information processing section 205 and the message outputted from DRX state management section 206 to the terminal.

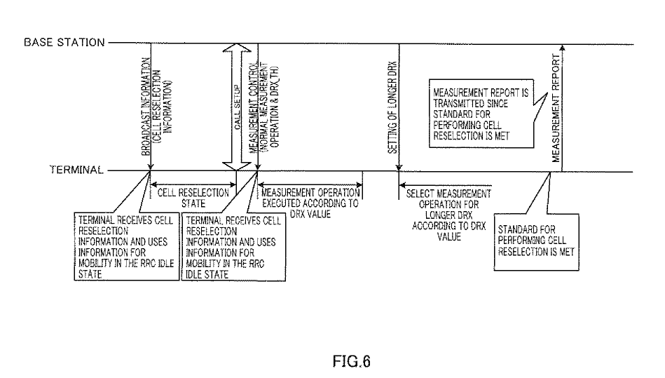

Next, the steps for communication between the terminal shown in FIG. 3 and the base station shown in FIG. 4 will be explained using FIG. 6. Cell reselection is generally performed in the RRC idle state, so that this measurement setup makes possible reduced power consumption of the terminal. Thus, suppose this measurement setup is also used in the RRC connected state using long DRX/DTX.

First, the terminal receives cell reselection information in broadcast information. The terminal receives the cell reselection information in the RRC idle state because the terminal needs the cell reselection information for mobility control in the RRC idle state. The terminal then performs the call setup and so on, transitions to the RRC connected state and receives the setup for handover such as measurement used when DRX/DTX is not performed under measurement control or the DRX/DTX interval is short.

The terminal performs the measurement operation using the setup. Furthermore, the terminal receives a threshold value of the DRX/DTX interval. After this, the terminal performs the DRX/DTX setup and performs measurement using information for cell reselection when the setup is longer than DRX_th. When the reference in performing cell reselection is satisfied using information for cell reselection, that is, when the condition for transition to other cells is met, a measurement report is transmitted, instead of cell reselection, to the currently connecting cell.

By such an operation, the setup for measurement for handover and so on to be transmitted to a terminal is prevented from becoming complex, and, furthermore, power consumption is reduced when the DRX/DTX interval is long.

Here, a case has been shown as an example where the setup for measurement for handover and so on are carried out under measurement control, but the setup thereof may also be performed in broadcast information. In that case, the setup for measurement for handover and so on received in broadcast information is used after a call setup, that is, after transition to the RRC connected state.

Next, the communication procedure shown in FIG. 6 will be explained in further detail. The terminal receives broadcast information in the RRC idle state. In this case, the terminal receives and stores information for cell reselection. The information for cell reselection has content as shown in FIG. 5A, for example. The information for cell reselection is sequentially processed in receiving section 101, broadcast information processing section 102 and cell reselection information processing section 105 in the terminal, and stored in cell reselection information processing section 105.

Necessary information is then outputted to measurement processing determining section 108 and measurement report transmission processing determining section 110. Here, in the RRC idle state, measurement processing determining section 108 and measurement report transmission processing determining section 110 are reported from DRX threshold/terminal state determining section 107 so that measurement processing determining section 108 and measurement report transmission processing determining section 110 both use information for cell reselection, and cell reselection is performed.

Measurement processing determining section 108 reports the determined measurement method to measurement execution section 109 and measurement execution section 109 executes measurement. The measurement result is outputted from measurement execution section 109 to measurement report transmission processing determining section 110. However, the measurement report is never sent in the RRC idle state.

Furthermore, when information for handover has also been acquired in broadcast information, the information for handover is sequentially processed in receiving section 101, broadcast information processing section 102 and handover information processing section 106. The necessary information is then outputted to measurement processing determining section 108 and measurement report transmission processing determining section 110.

Next, when the terminal transitions to the RRC connected state by a call setup and so on, individual handover information processing section 103 reports to DRX threshold/terminal state determining section 107 that the terminal has transitioned, and the state of the terminal is determined again. Information about measurement and DRX_th and so on have already been reported in broadcast information, so that, upon transition to the RRC connected state, if the value of DRX/DTX used by the terminal is smaller than DRX_th, DRX threshold/terminal state determining section 107 commands measurement processing determining section 108 and measurement report transmission processing determining section 110 to use the setup for handover. As a result, measurement processing determining section 108 changes the setup for cell reselection to the setup for handover, and reports the changed setup to measurement execution section 109. Measurement processing determining section 108 also reports to measurement report transmission processing determining section 110 that the setup for cell reselection has been changed to the setup for handover, and measurement report transmission processing determining section 110 determines transmitting a measurement report. When the value of DRX/DTX used by the terminal in this case is greater than DRX_th, DRX threshold/terminal state determining section 107 commands measurement processing determining section 108 and measurement report transmission processing determining section 110 to use the setup for cell reselection as is. However, since measurement report transmission processing determining section 110 needs to send the measurement report to transmitting section 111, DRX threshold/terminal state determining section 107 controls measurement report transmission processing determining section 110 so as to output the measurement report to transmitting section 111.

Furthermore, here, when the terminal acquires individual information for handover, that is, the setup for measurement for handover such as measurement control, control information thereof is sequentially processed in receiving section 101, individual handover information processing section 103 and handover information processing section 106, and stored in handover information processing section 106. The individual information for handover has content similar to those of the information for handover included in broadcast information, for example, the content shown in FIG. 5B.

Next, a case where when the value of DRX/DTX used by the terminal is smaller than DRX_th, the setup of a long DRX is transmitted from the base station as shown in FIG. 6. The DRX setup transmitted from the base station is sequentially processed in receiving section 101 and DRX state management section 104, and DRX state management section 104 controls DRX/DTX according to the transmitted DRX setup. This control may be performed by MAC (Medium Access control) or by using RRC messages. Furthermore, DRX/DTX may be controlled without explicitly sending messages. To be more specific, if no data is received for a predetermined time, the DRX/DTX interval may be extended or the DRX/DTX interval may be shortened after data is received. In this case, DRX state management section 104 manages a DRX/DTX control rule and receiving section 101 reports reception or no reception of data to DRX state management section 104, and the control can be realized in this way. Thus, DRX state management section 104 manages DRX/DTX and outputs DRX/DTX to DRX threshold/terminal state determining section 107 irrespective of the scheme of DRX/DTX control.

When a newly set-up DRX/DTX interval is shorter than DRX_th, DRX threshold/terminal state determining section 107 does not perform processing at this time. On the other hand, when the newly set-up DRX/DTX interval is longer than DRX_th, DRX threshold/terminal state determining section 107 reports to measurement processing determining section 108 and measurement report transmission processing determining section 110 that the information to be used will be changed.

Measurement processing determining section 108 performs the setup for cell reselection, determines to perform measurement and reports the setup to measurement execution section 109. This makes it possible to realize measurement with low power consumption using information for cell reselection. Furthermore, measurement report transmission processing determining section 110 determines whether or not the measurement result from measurement execution section 109 satisfies the condition of cell reselection, that is, the condition for transition to other cells, using information for cell reselection.

When the condition of cell reselection is satisfied, measurement report transmission processing determining section 110 transmits the measurement report to the base station currently being connected instead of executing cell reselection. This is to realize network-based mobility. The processing such as handover hereafter is similar to normal handover processing.

Thus, according to Embodiment 1, if the DRX/DTX interval set for a terminal in the RRC connected state, is longer than DRX_th, measurement is performed using information for cell reselection, and a measurement report is transmitted to the currently connecting radio communication base station apparatus on condition that the measurement result meets the cell reselection standard, thereby controlling a measurement operation suitable for long DRX/DTX intervals without providing additional signaling between the terminal and base station.

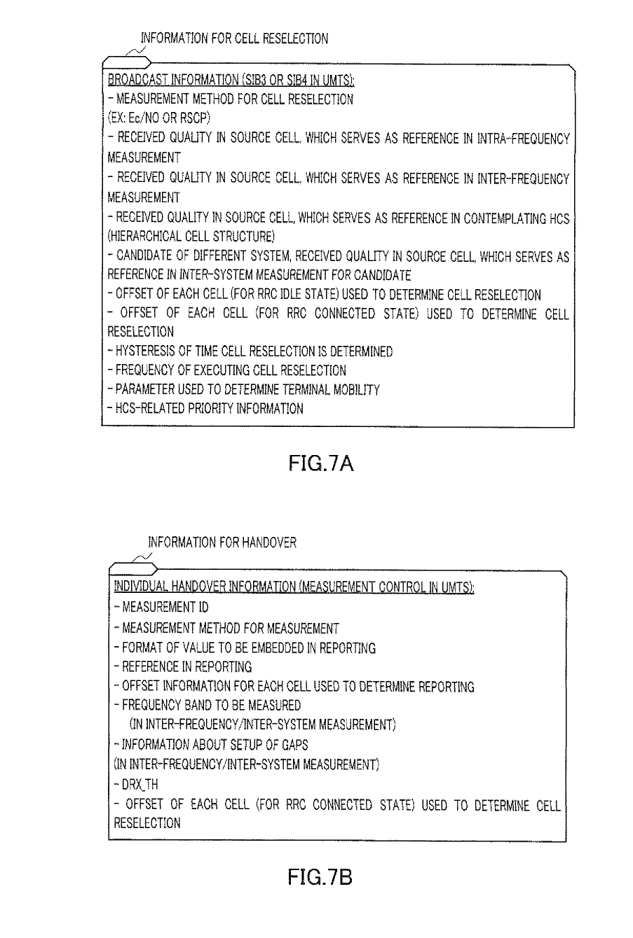

The present embodiment uses long DRX/DTX in the RRC connected state, in the same information as in the RRC idle state, but, as shown in FIG. 5A, the values used in long DRX/DTX may also embedded in broadcast information for cell reselection. To be more specific, as shown in FIG. 7A, part of information may assume different values between the RRC idle state and the RRC connected state. Furthermore, when different values are used in this the RRC connected state, this value alone may be embedded in individual handover information.

Furthermore, the present embodiment has not particularly mentioned the roles of RRC (Radio Resource control) and MAC and so on, but the present embodiment can be implemented by mounting part of the aforementioned functions in RRC and the rest of the functions in MAC. How to divide the functions and what protocol should be used, may be determined as appropriate.

### Embodiment 2

Although a case has been explained above with Embodiment 1 where a terminal in the RRC connected state, for which long DRX/DTX is set up uses all information for cell reselection used in the RRC idle state, a case will be described below with Embodiment 2 of the present invention where all information for cell reselection used in the RRC idle state, is not used, but only part of the information is used. To be more specific, information to be used can be limited by processing of one of (1 ) to (4) below. That is, (1) information to be used is reported in individual handover control information, (2) information to be used is reported in broadcast information, (3) information to be used is determined in advance using Spec and so on, and (4) information to be used is set up in the terminal in advance.

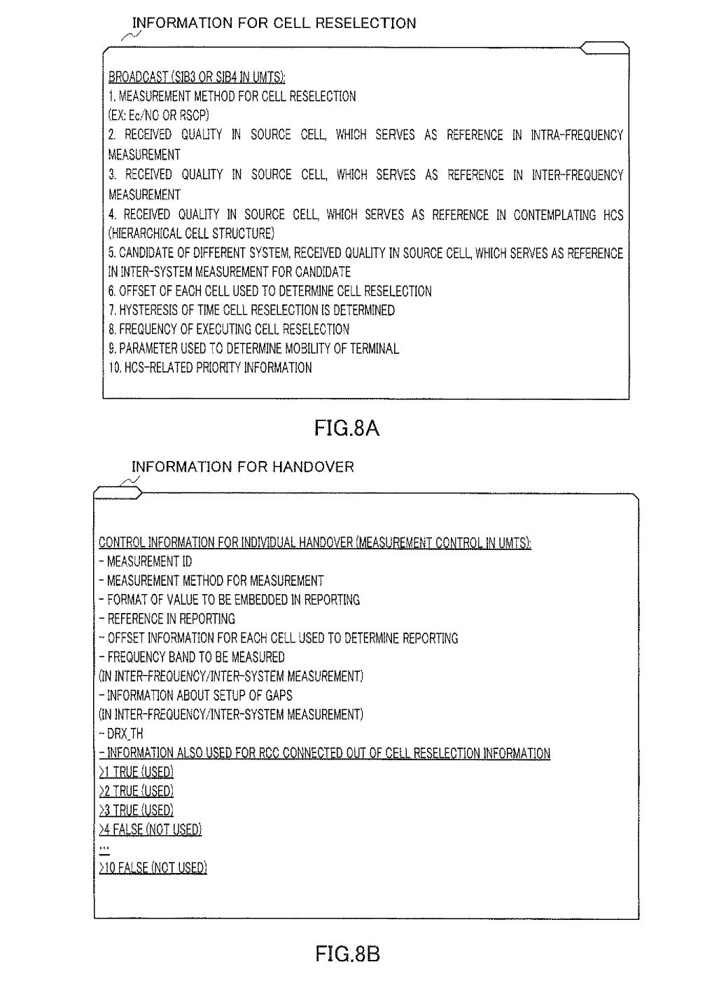

Here, FIG. 8 shows content of individual handover control information that reports information to be used. FIG. 8A is information for cell reselection. Here, indices 1 to 10 are assigned to respective pieces of information for convenience. FIG. 8B shows individual handover information, illustrating which cell reselection information should be used. For example, as for HCS-related information, indices 4 and 10 corresponding to HCS, are set to “false” (not used).

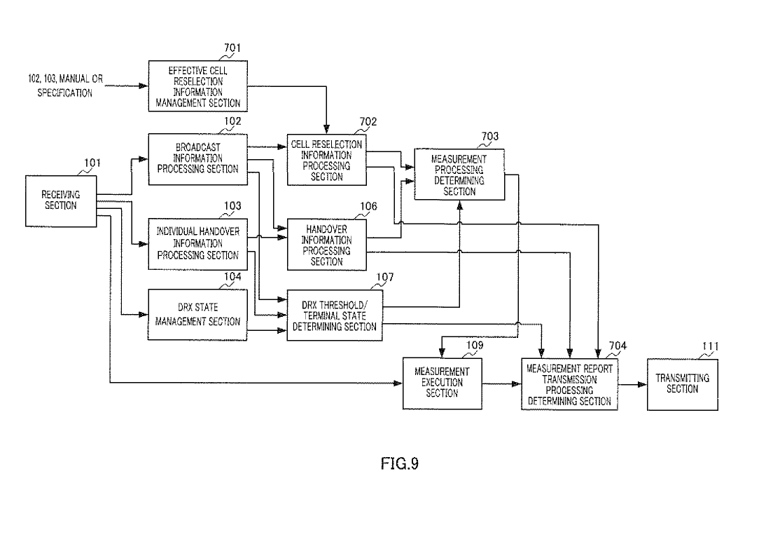

FIG. 9 is a block diagram showing a configuration of a terminal according to Embodiment 2 of the present invention. However, FIG. 9 is different from FIG. 3 in that effective cell reselection information management section 701 is added, cell reselection information processing section 105 is changed to cell reselection information processing section 702, measurement processing determining section 108 is changed to measurement processing determining section 703, and measurement report transmission processing determining section 110 is changed to measurement report transmission processing determining section 704.

Effective cell reselection information management section 701 manages which cell reselection information should be used by a terminal in the RRC connected state. As a more specific management method, when the information to be used is reported in individual handover control information, individual handover information processing section 103 commands effective cell reselection information management section 701 and effective cell reselection information management section 701 determines the information to be used. On the other hand, when the information to be used is reported in broadcast information, broadcast information processing section 102 commands effective cell reselection information management section 701, and effective cell reselection information management section 701 determines the information to be used. Furthermore, when information to be used is determined in advance by Spec and so on in advance or when the information to be used is set up in the terminal in advance, information is set in advance in effective cell reselection information management section 701.

Cell reselection information processing section 702 manages cell reselection information to be used by a terminal in the RRC connected state, based on information outputted from effective cell reselection information management section 701, and reports the managed information to measurement processing determining section 703 and measurement report transmission processing determining section 704.

Measurement processing determining section 703 also manages information for cell reselection to be used by a terminal in the RRC connected state, newly reported from cell reselection information processing section 702, and, when the terminal in the RRC connected state, uses information for cell reselection, uses this information.

Measurement report transmission processing determining section 704 also manages information for cell reselection to be used by the terminal in the RRC connected state, newly reported from cell reselection information processing section 702 and, when the terminal in the RRC connected state, uses information for cell reselection, uses this information.

Thus, information for cell reselection to be used by a terminal in the RRC connected state, can be limited. Specific examples of this include not using HCS as described above and not performing inter-system measurement. Furthermore, when information about a plurality of different systems is included in the cell reselection information, measurement of a specific different system may not be performed either.

Thus, Embodiment 2 uses information of only part of information for cell reselection used in the RRC idle state, and can thereby perform setting more suitable for a terminal in the RRC connected state and accurately control the measurement operation.

### Embodiment 3

Although a case has been explained above with Embodiment 1 where a terminal in the RRC connected state, for which a long DRX is set up uses only information for cell reselection, a case will be explained below with Embodiment 3 of the present invention where information for cell reselection and information for handover are managed on a per group basis and where information belonging to the same group is used together.

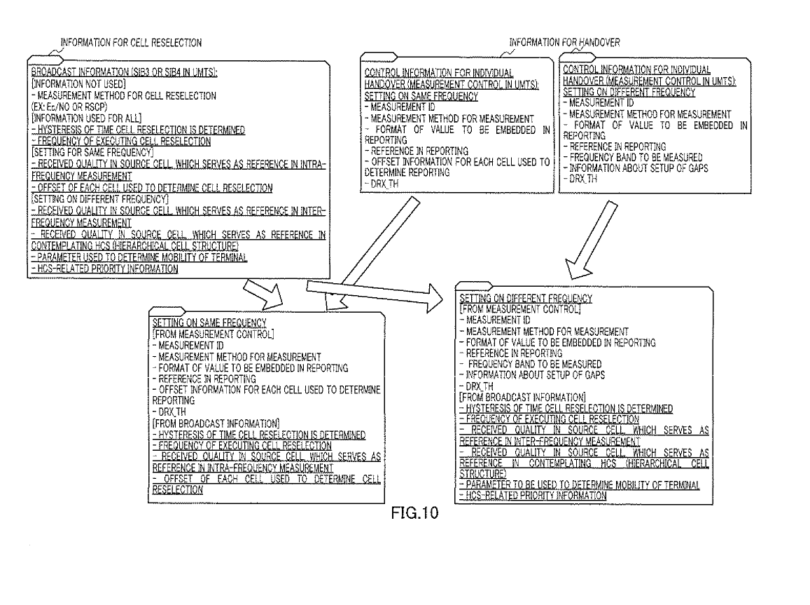

FIG. 10 shows how information for cell reselection and information for handover are managed on a per group basis. Here, two groups will be used: a group of setups for the same frequency and a group of setups for a different frequency. Furthermore, as control information for individual handover, a message for the same frequency and a message for a different frequency are transmitted. On the other hand, although information for cell reselection is one message, distinctions are made between the information not used, the information used for all, the setup for the same frequency, the setup for a different frequency, and so on. A message itself needs not be divided in this way, but it is only required that how to perform control be determined.

In this example, the measurement method for cell reselection is example of information not used, and the information is not used as handover control information. Furthermore, information used for all is used for both the setup for the same frequency and the setup for a different frequency. Here, the hysteresis of the time cell reselection is determined and the frequency of executing cell reselection are examples of information used for all. Furthermore, the setup for the same frequency is not used as the setup for a different frequency. Here, the received quality in the source cell, which serves as a reference in intra-frequency measurement and offset of each cell used to determine cell reselection and so on are examples of the setup for the same frequency. Furthermore, the setup for a different frequency is not used as the setup for the same frequency. Here, the received quality in the source cell, which serves as a reference in inter-frequency measurement, is an example of the setup for a different frequency.

Such an operation makes it possible to use both information for cell reselection and handover control information and realize effective processing.

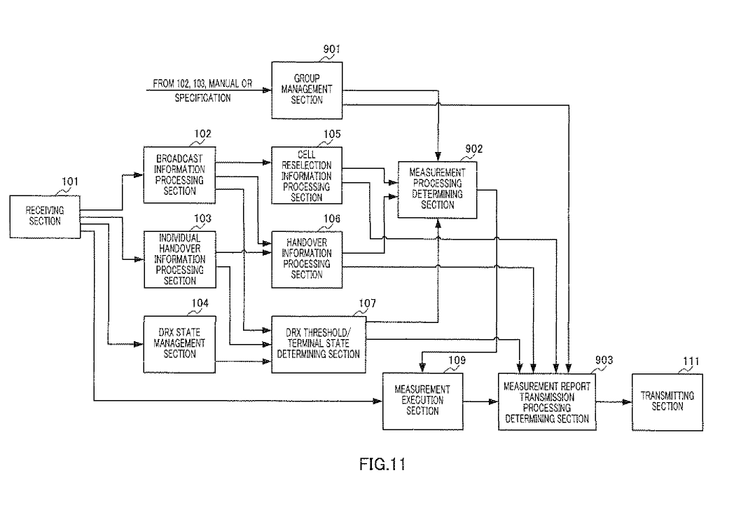

FIG. 11 is a block diagram showing a configuration of a terminal according to Embodiment 3 of the present invention. However, FIG. 11 is different from FIG. 3 in that group management section 901 is added, measurement processing determining section 108 is changed to measurement processing determining section 902 and measurement report transmission processing determining section 110 is changed to measurement report transmission processing determining section 903.

Group management section 901 manages the above described groups and determines the setups to be used in measurement processing determining section 902 and measurement report transmission processing determining section 903 according to the groups managed. There can also be four methods of creating a group as shown in Embodiment 2 and depending on which method is used, broadcast information processing section 102 may command group management section 901, individual handover information processing section 103 may command group management section 901 or information may be set in group management section 901 in advance.

Measurement processing determining section 902 integrates information belonging to the same group according to commands from group management section 901.

Measurement report transmission processing determining section 903 integrates information belonging to the same group according to commands from group management section 901.

Thus, Embodiment 3 can use both information for cell reselection and information for handover, and thereby realize effective processing.

The present embodiment has shown the same frequency and a different frequency as group examples, but a different system may also be considered as one group.

The information for cell reselection can further be subdivided into smaller groups. In such a case, it is possible to set up as to which group should be used for the same frequency and a different frequency. The operation in this case is an operation that combines Embodiment 3 and Embodiment 2.

The information shown in the present overview is an example and other information may be used as well or other methods may be used as well to determine what should be grouped and how.

### Embodiment 4

Although a case has been explained above with Embodiment 1 where only one DRX_th is compared with DRX/DTX, a case will be explained below with Embodiment 4 of the present invention where a plurality of DRX_th's will be compared with DRX/DTX.

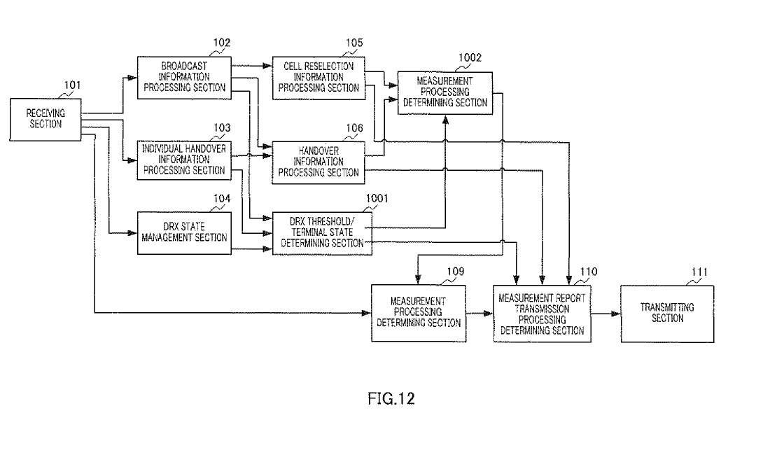

FIG. 12 is a block diagram showing a configuration of a terminal according to Embodiment 4 of the present invention. However, FIG, 12 is different from FIG. 3 in that DRX threshold/terminal state determining section 107 is changed to DRX threshold/terminal state determining section 1001 and measurement processing determining section 108 is changed to measurement processing determining section 1002.

When the state of the terminal reported from individual handover information processing section 103 is the RRC idle state, DRX threshold/terminal state determining section 1001 determines to use information for cell reselection. On the other hand, when a terminal is in the RRC connected state, DRX threshold/terminal state determining section 1001 compares the length of DRX/DTX currently being used outputted from DRX state management section 104 with DRX_th for each of a plurality of measurement processes, and determines which of the setup for cell reselection or the setup for handover should be used for each of a plurality of measurement processes based on the comparison result as to whether or not the length of DRX/DTX currently being used is longer than DRX_th. To be more specific, when the length of DRX/DTX is longer than DRX_th, measurement is determined to be performed using the setup for cell reselection, and, when the length of DRX/DTX is shorter than DRX_th, measurement is determined to be performed using the setup for handover. As the determination result, DRX threshold/terminal state determining section 1001 specifies the setup to be used, to measurement processing determining section 1002 and measurement report transmission processing determining section 110. Examples of a plurality of measurement processes include the process of intra-frequency measurement, a process of inter-frequency measurement of the same system, a process of inter-system measurement, and so on.

According to the setup commanded from DRX threshold/terminal state determining section 1001, measurement processing determining section 1002 selects one of information for cell reselection outputted from cell reselection information processing section 105 and information for handover outputted from handover information processing section 106 and commands measurement execution section 109 about the measurement setup using the selected information. The measurement setup is specified, to measurement execution section 109, in each of a plurality of measurement processes.

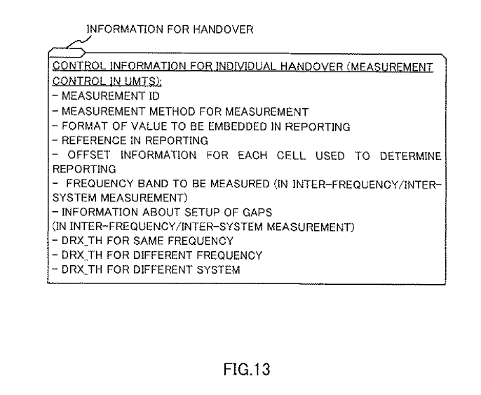

Here, FIG. 13 shows information for handover. As shown in FIG. 13, information for handover includes the DRX_th for the same frequency, the DRX_th for a different frequency and the DRX_th for a different system. Thus, the DRX_th for the same frequency is used to determine whether intra-frequency measurement is performed using information for handover or using information for cell reselection. Furthermore, the DRX_th for a different frequency is used to determine whether inter-frequency measurement is performed using information for handover or using information for cell reselection.

Hereinafter, the reason that different DRX_th's are used depending on the content of measurement, will be explained. First, the reason is related to the fact that inter-frequency measurement or inter-system measurement requires a period (gap) during which a connection to the currently communicating cell is stopped and requires the period to be set up in DRX. That is, since gap needs not be considered in intra-frequency measurement, information for cell reselection can be used for a power reduction even for a relatively short DRX. However, when the DRX value is small, since a sufficient gap cannot be used for the short DRX, information for cell reselection may not be applicable to inter-frequency measurement or inter-system measurement. For such a reason, it is effective to set up different DRX_th's depending on the content of measurement. Furthermore, as for inter-frequency measurement and inter-system measurement, intersystem measurement generally takes more time and requires a longer gap than inter-frequency measurement. This is also a factor that makes it effective to provide varying DRX_th's.

Thus, Embodiment 4 uses different DRX_th's such as the DRX_th for the same frequency, DRX_th for a different frequency and DRX_th for a different system depending on the content of measurement, and can thereby determine whether or not the DRX that is set up is long enough to apply information for cell reselection for each measurement process.

The present embodiment provides three DRX_th's for the same frequency, for a different frequency and for a different system, respectively, but other setting methods may be used as well. To be more specific, two DRX_th's may be set up for the same frequency and for other cases or two DRX_th's may be set up for the same system and for a different system.

Furthermore, the present embodiment provides three separate DRX_th's for the same frequency, for a different frequency and for a different system, but when there are DRX_th 's to be transmitted and DRX_th's not to be transmitted among the three DRX_th's, only the DRX_th's that are transmitted may be used. To be more specific, when only the DRX_th for the same frequency is transmitted, information for cell reselection may be used only for intra-frequency measurement and information for cell reselection may not be used for different frequencies or for a different system.

Furthermore, only partial processing content may be set up as measurement for handover. To be more specific, information for the same frequency, for a different frequency and for a different system is provided as information for cell reselection, but measurement processing for handover is set up only for the same frequency or only for the same frequency and different frequency. In such a case, as for measurement for which measurement processing for handover is set up, it may be possible to determine whether to use the parameters for measurement for handover based on the DRX_th or use information for cell reselection, determine not to perform measurement for measurement for which measurement processing for handover is not specified based on the DRX_th or perform measurement using information for cell reselection. That is, when the setup for measurement processing for cell reselection for a different frequency is reported in broadcast in formation and the setup for measurement processing for handover to a different frequency is reported to the terminal neither in broadcast information nor in any individual messages, inter-frequency measurement is not executed when shorter DRX than DRX_th for a different frequency is set for a terminal, whereas, when longer DRX than DRX_th for a different frequency is set for a terminal, inter-frequency measurement is performed using the setup for measurement processing for cell reselection.

Furthermore, contrary to the above description, as for measurement for which measurement processing for handover is not set up, an operation that prevents measurement processing from being executed irrespective of the value of the DRX_th, is also possible.

Furthermore, although an example has been explained above with the present embodiment where the DRX_th value is reported from the network in individual messages, but this value may be reported in broadcast information or defined as a specification in advance, so that the DRX_th value is not sent from the network.

Furthermore, the present embodiment has described the method of reporting a plurality of values of DRX_th's, but it is also possible to define the rule for determining values of other DRX_th's from a value of one DRX_th and reporting the value of only one DRX_th from the network. For example, it is possible to define such a rule that a value of the DRX_th for the same frequency is multiplied by 1.5 to calculate a DRX_th for a different frequency, report only the DRX_th for the same frequency from the network and determine DRX_th for a different frequency on the terminal side and so on.

In the present embodiment, values of a plurality of DRX_th's are reported through one individual message from a network, but values of a plurality of DRX_th's may also be reported in different messages, for example, the DRX_th for the same frequency may be reported in the setup message for handover to the same frequency and DRX_th for a different frequency may be reported in the setup message for handover to a different frequency.

### Embodiment 5

Although a case has been explained above with Embodiment 1 where the value of DRX is equal to or greater than DRX_th as the condition for using information for cell reselection, a case will be explained below with Embodiment 5 of the present invention where the measurement result in the subject cell is used as the condition for using information for cell reselection in addition to the case where the value of DRX is equal to or greater than DRX_th.

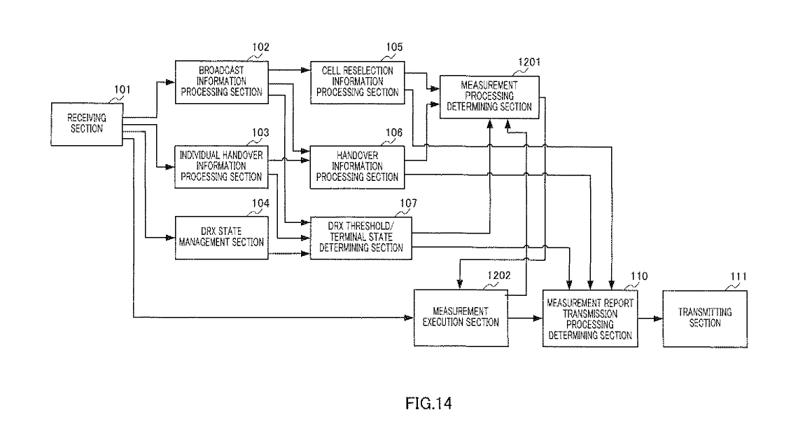

FIG. 14 is a block diagram showing a configuration of a terminal according to Embodiment 5 of the present invention. However, FIG. 14 is different from FIG. 3 in that measurement processing determining section 108 is changed to measurement processing determining section 1201 and measurement execution section 109 is changed to measurement execution section 1202.

Measurement processing determining section 1201 selects one of information for cell reselection outputted from cell reselection information processing section 105 and information for handover outputted from handover information processing section 106, based on the setup outputted from DRX threshold/terminal state determining section 107 and the measurement result outputted from measurement execution section 1202, which will be described later, and commands measurement execution section 1202 to set up measurement using the selected information.

Measurement execution section 1202 executes measurement by actually using a received signal (to be more specific, reference signal such as common pilot channel (CPICH) in UMTS and so on or a reference signal of a different channel when such a channel is used as a reference signal in LTE and so on) and transmits the measurement result to measurement report transmission processing determining section 110. Furthermore, when the measurement result falls below a specific value, measurement execution section 1202 reports the fact to measurement processing determining section 1201. The “specific value” is the received quality value in the subject cell, which serves as a reference in inter-cell measurement.

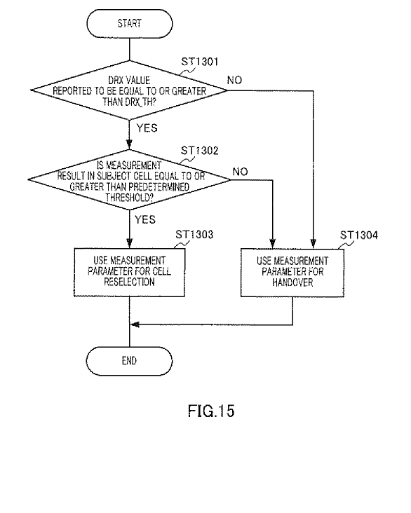

Next, detailed operations of aforementioned measurement processing determining section 1201 will be explained using FIG. 15. Referring to FIG. 15, it is determined in step (hereinafter abbreviated as “ST”) 1301 whether or not the value of DRX is reported to be equal to or greater than DRX_th according to commands from DRX threshold/terminal state determining section 107. When the value of DRX is reported to be equal to or greater than DRX_th (“YES”), the step moves to ST 1302 or moves to ST 1304 when the value of DRX is reported to be less than DRX_th (“NO”).

In ST 1302, it is determined whether the measurement result in the subject cell reported from measurement execution section 1202 is equal to or greater than a predetermined threshold (received quality in the subject cell, which serves as a reference in inter-cell measurement), the step moves to ST 1303 when the measurement result in the subject cell is equal to or greater than the predetermined threshold (“YES”) or moves to ST 1304 when the measurement result in the subject cell is less than the predetermined threshold (“NO”). Here, specific examples of the received quality in the subject cell that is used as a predetermined threshold and that provides a reference in measurement in other cells include S_{intrasearch} defined for intra-frequency measurement in UMTS, S_{intersearch} defined for inter-frequency measurement and S_{search,RAT} defined for inter-system measurement.

In ST 1303, it is determined that measurement is performed using the measurement parameters for cell reselection. On the other hand, in ST 1304, it is determined that measurement is performed using the measurement parameters for handover.

Such processing makes it possible to reduce the amount of processing for measurement using the measurement parameters for cell reselection, reduce the power consumption of the terminal and perform processing suitable for handover using the measurement parameters for handover in an environment in which there is a possibility of handover to other cells.

Thus, according to Embodiment 5, when the value of DRX is equal to or greater than DRX_th and the measurement result in the subject cell is equal to or greater than a predetermined threshold, it is possible to use information for cell reselection, using information for cell reselection, only when the possibility of handover is low.

As in UMTS, when a plurality of received quality values in the subject cell, which serves as a reference in inter-cell measurement (for the same frequency, for a different frequency, for a different system), the determination as to whether or not use the parameters for cell reselection in ST 1302 shown in FIG. 15 is used varies depending on the content of the measurement process. To be more specific, when the threshold (S_{intersearch} in UMTS) of received quality in the subject cell defined as a reference to determine whether or not to perform measurement for other cells of different frequencies is lower than a threshold (S_{intrasearch} in UMTS) of received quality in the subject cell defined as a reference in determining whether or not to perform measurement for other cells of the same frequency, measurement for other cells of different frequencies may not be required to be performed even if measurement for other cells of the same frequency needs to be performed. In such a case, measurement parameters for handover are used for the same frequency and measurement parameters for cell reselection are used for different frequencies.

### Other Embodiments

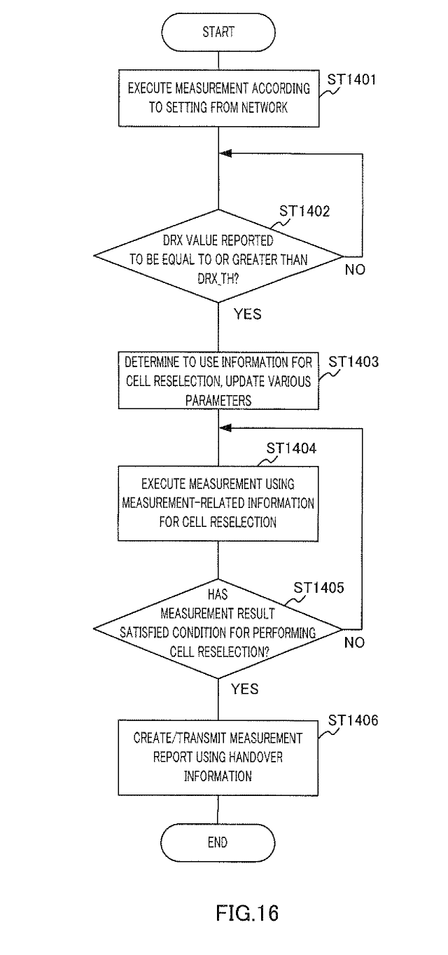

A method will be described now whereby a terminal uses the information for cell reselection explained in Embodiment 1. FIG. 16 is a flowchart showing the operation of the terminal when longer DRX than DRX_th is set.

Referring to FIG. 16, in ST 1401, measurement is executed according to the setup from the network, and, in ST 1402, it is determined whether or not the value of DRX is reported to be equal to or greater than DRX_th. When the value of DRX is reported to be equal to or greater than DRX_th (“YES”), the step moves to ST 1403, whereas, when the value of DRX is reported to be less than DRX_th (“NO”), the step returns to ST 1402.

In ST 1403, the use of information for cell reselection is determined and various parameters are updated, and, in ST 1404, measurement is executed using measurement-related information for cell reselection.

In ST 1405, it is determined whether or not the measurement result meets the condition for performing cell reselection and the step moves to ST 1406 when the condition for performing cell reselection is met (“YES”) or returns to ST 1404 when the condition for performing cell reselection is not met (“NO”). In ST 1406, a measurement report is created and transmitted using handover information.

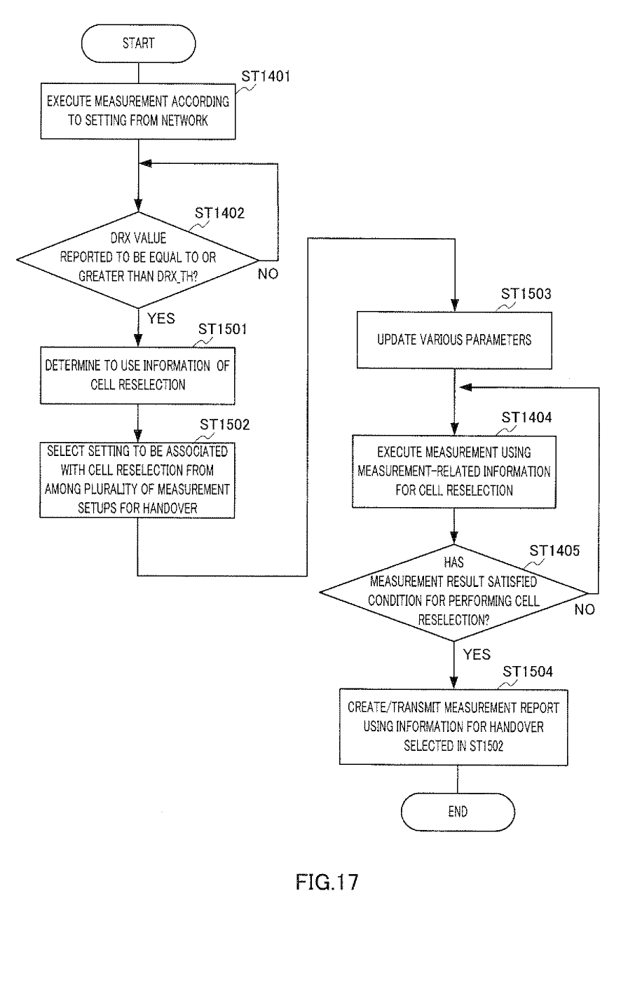

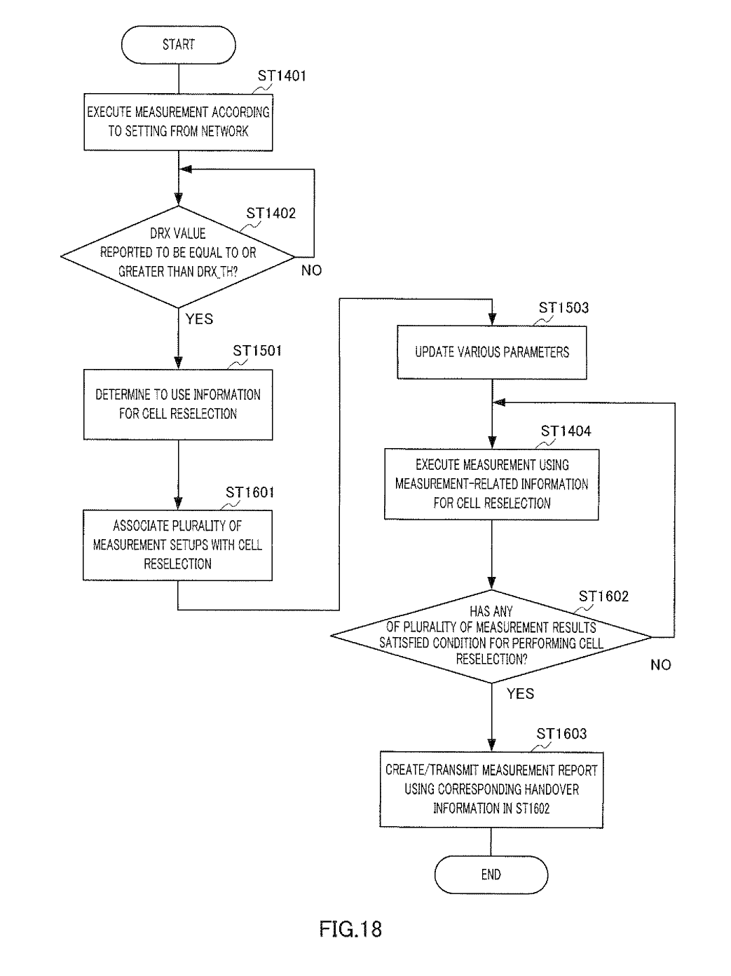

The operation shown in FIG. 16 assumes a case where there is one measurement setup for handover, but, when there are a plurality of measurement setups, further operations are necessary. When there is only one condition for performing cell reselection, two types of terminal operations are possible, and these operations will be explained using FIG. 17 and FIG. 18. Referring to FIG. 17, parts common to those in FIG. 16 will be assigned the same reference numerals and overlapping explanations will be omitted.

Referring to FIG. 17, the use of information for cell reselection is determined in ST 1501, and the measurement setup for handover to be associated with cell reselection is selected from among a plurality of measurement setups for handover in ST 1502. In ST 1503, various parameters are updated.

In ST 1504, when it is determined in ST 1405 that the measurement result meets the condition for performing cell reselection, a measurement report is created and transmitted using the information for handover selected in ST 1502. That is, the measurement ID shown in FIG. 5B and the format of values to be embedded in reporting and so on, are used here to create a message.

Next, another operation of the terminal will be explained using FIG. 18. Referring to FIG. 18, parts common to those in FIG. 17 will be assigned the same reference numerals and overlapping explanations will be omitted.

Referring to FIG. 18, in ST 1601, among a plurality of measurement setups for handover, the ones with differences in the measurement setup are grouped together and associated with cell reselection. Here, the “measurement setup” refers to, for example, the method of measurement. Thus, measurement is performed for each grouped measurement setup, and therefore measurement with a plurality of setups can be performed in parallel.

In ST 1602, it is determined whether or not there are ones among a plurality of measurement results that meet the condition for performing cell reselection, and, when there is a measurement result to meet the condition (“YES”), the step moves to ST 1603 or returns to ST 1404 when there is no measurement result to meet the condition (“NO”). In ST 1603, a measurement report is created and transmitted using the corresponding handover information in ST 1602.

Examples of measurement setups selected in ST 1502 of FIG. 17 and measurement setups selected in ST 1601 of FIG. 18 include the initial measurement setup in the terminal, the measurement setup having the smallest (or largest) measurement ID, measurement setups in which the same reporting is performed as in cell reselection, measurement setups reported in broadcast information, and measurement setups reported in individual messages. By the way, examples of measurement setups in which the same reporting is performed as in cell reselection include the measurement setup that issues a report when the best cell or system changes, instead of issuing a report when a cell is added. That is, “Event 1d” indicating that the best cell of the same frequency band in UMTS has changed, “Event 2a” indicating that the best cell among different frequency bands has changed and “Event 3d” indicating that the best cell among different systems has changed, are examples. Furthermore, the measurement setup reported in broadcast information is selected because the setup reported in broadcast information is regarded as the most general setup and the measurement setup reported in an individual message is selected because the individual message is regarded as the most important setup to the terminal to which the individual message has been transmitted.

Furthermore, examples of information grouping the same measurement setups in ST 1601 of FIG. 18 include measurement methods such as Ec/NO, SIR, RSCP (received signal code power), path loss and bands subject to measurement such as 1.25 MHz, 2.5 MHz, all bands, etc. Thus, by performing measurement using the SIR to follow the trends of downlink and by performing measurement using the RSCP to follow the trends of uplink, it is possible to perform processes in parallel in accordance with measurement characteristics. Therefore, it is possible to manage more situations and improve mobility control,

Although the above embodiments have been explained without particularly distinguishing between DRX and DTX, when these are distinguished, one of DRX and DTX having the smaller value may be used for comparison with DRX_th.

Furthermore, although the above embodiments have been explained assuming that the operation switches immediately when a DRX value exceeding DRX_th is set up, hysteresis, that is, a kind of grace period, may be provided for switching between operations. To be more specific, even when a DRX value exceeding DRX_th is set, it is possible to continue the ongoing operation for the duration of hysteresis without switching the operation immediately. The same applies to a case where a DRX value not exceeding DRX_th is set in a state in which a DRX value exceeding DRX_th is set. Furthermore, hysteresis may be reported in broadcast information, reported in an individual RRC message, or may be a fixed value.

Furthermore, both measurement operation for cell reselection and measurement operation for handover may be executed during the hysteresis to thereby smoothly switch between the operations.

The above embodiments may be implemented in combination with each other as appropriate.

The source cell in the above embodiments may be the currently connecting cell or may be a cell connected in the past.

Furthermore, measurement for handover in the above embodiments refers to a measurement control message, which is an RRC message in UMTS, system information block type 11, which is broadcast information or information sent in system information block type 11 and so on, and is measurement used when a terminal establishes an RRC connection and transfer of the terminal is controlled by the network. Examples of states of a terminal in which these are used include CELL_DCH in RRC_CONNECTED of UMTS, and RRC_CONNECTED and LTE_ACTIVE in LTE.

Furthermore, measurement for cell reselection in the above embodiments is information sent in system information block type 3 which is broadcast information in UMTS and refers to measurement used when the terminal controls movement by itself. Examples of states of a terminal in which these are used include RRC_IDLE in UMTS, and CELL_FACH, CELL_PCH and URA_PCH in RRC_CONNECTED. Other examples include the RRC_IDLE state and LTE_IDLE state in LTE.

Furthermore, DRX_th in the above embodiments is information indicating the length of DRX, but the length of DRX need not directly be reported as DRX_th. To be more specific, when the length of DRX is expressed as 2̂K, K can be transmitted as DRX_th. In such a case, comparison processing is possible by determining the length of DRX from DRX_th and so on and comparing the length of DRX with the length of DRX currently used by the terminal.

Furthermore, although cases have been shown above with the embodiments as examples of comparison between DRX_th and DRX currently used by the terminal where comparison processing is performed depending on whether or not the DRX value currently used by the terminal is longer than DRX_th, but operation may also be possible whereby the comparison processing is performed depending on whether or not the DRX value currently used by the terminal is equal to or greater than the length of DRX_th.

Although cases have been described with the embodiments above where the present invention is configured by hardware, the present invention may be implemented by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC”, “system LSI”, “super LSI”, or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-092776, filed on Mar. 30, 2007 and Japanese Patent Application No. 2007-120849, filed on May 1, 2007, including the specification, drawings and abstract, is incorporated herein by reference in its entirety.

### INDUSTRIAL APPLICABILITY

The radio communication terminal apparatus and radio communication method according to the present invention are applicable, for example, to a mobile communication system.

1. A radio communication terminal apparatus comprising:
a determining section that determines whether or not a discontinuous reception/discontinuous transmission interval in a radio resource control connected state is longer than a predetermined value;
a measurement section that performs measurement using information for cell reselection when the discontinuous reception/discontinuous transmission interval is longer than the to predetermined value; and
a transmission section that transmits a measurement report to a currently connecting radio communication base station apparatus, on condition that the measurement result meets the cell reselection standard.

2. The radio communication terminal apparatus according to claim 1, wherein the measurement section performs measurement using limited information for cell reselection.

3. The radio communication terminal apparatus according to claim 1, further comprising a group management section that groups and manages an information element for cell reselection and an information element for handover, wherein:
the measurement section integrates information belonging to a group specified in the group management section, and performs measurement using the integrated information.

4. The radio communication terminal apparatus according to claim 1, wherein the determining section determines whether or not the discontinuous reception/discontinuous transmission interval is longer than a predetermined value which varies depending on measurement content.

5. The radio communication terminal apparatus according to claim 1, wherein when the discontinuous reception/discontinuous transmission interval is longer than the predetermined value and the measurement result is greater than a second predetermined value, the measurement section performs measurement using in formation for cell reselection.

6. A radio communication method comprising:
a determining step of determining whether or not a discontinuous reception/discontinuous transmission interval in a radio resource control connected state is longer than a predetermined value;
a measurement step of performing measurement using information for cell reselection when the discontinuous reception/discontinuous transmission interval is longer than the predetermined value; and
a transmission step of transmitting a measurement report to a currently connecting radio communication base station apparatus, on condition that the measurement result meets the cell reselection standard.
